(19) United States
(12) Patent Application Publication
(10) Pub. No.: US 2013/0118252 A1
(43) Pub. Date: May 16, 2013

(54) MEASUREMENT DEVICE

(71) Applicant: Seuffer GmbH & Co. KG, Calw (DE)

(72) Inventor: Thomas Hartmann, Filderstadt-Bernhausen (DE)

(73) Assignee: Seuffer GmbH & Co. KG, Calw (DE)

(21) Appl. No.: 13/674,299

(22) Filed: Nov. 12, 2012

(30) Foreign Application Priority Data
Nov. 16, 2011 (DE) 10 2011 118 711.5

(51) Int. Cl. G01F 23/296

(52) U.S. Cl. CPC G01F 23/296
USPC 73/290 V

(57) ABSTRACT

The present invention concerns a measuring apparatus for detecting a filling level of a fluid (F) in a tank (T) by means of ultrasound signals. The measuring apparatus comprises a sensor unit (3) adapted to transmit and receive ultrasound signals, and an evaluation device (40) adapted to evaluate the received ultrasound signals. The sensor unit (3) and the evaluation device (40) are arranged on a common assembly (4), and the assembly (4) is arranged in a housing (2) of the measuring apparatus (1). That provides for accurate measurement of even low filling levels.

The present invention concerns a measuring apparatus or detection apparatus and in particular a detection apparatus for detecting a filling level or a filling height in a container by means of ultrasound.

If for example fuels are carried around in a motor vehicle or if fuels are stored in containers and tanks in connection with a machine to be operated it is then necessary to provide a tank or container which is suited thereto and which is adapted in its configuration to the vehicle or machine. Furthermore information in regard to the filling level of the fuels in the container or tank is required to estimate operating times or a measure for supplementing the supplies of fuels. Substantially mechanically operating filling level measuring devices are known.

An application for a detection apparatus for the filling level in a tank is known for example in the operation of diesel machines in which there is provided a particular exhaust gas cleaning system so that environmentally harmful substances contained in the exhaust gases from combustion are at least partially eliminated or converted. Combustion for example of diesel fuel in diesel vehicle engines produces in the exhaust gases nitrogen oxides which can be considerably reduced if gaseous ammonia is introduced into the flow of exhaust gas as a reducing agent. The gaseous ammonia selectively reacts with the nitrogen oxides in the exhaust gas to give nitrogen and water.

In an application in the area of internal combustion engines for fuels, an aqueous urea solution is used to prepare ammonia, the solution being carried around in the vehicle in its own tank. The aqueous urea solution is introduced into the flow of exhaust gas of the diesel combustion engine by means of a metering valve.

The aqueous urea solution has to be stored in a smaller amount in a separate tank, in addition to the actual fuel for the internal combustion engine. Accordingly the machine to be operated or a diesel internal combustion engine requires in the vehicle or also at a stationary location the further tank or generally a container for storing for example the aqueous urea solution.

It is necessary in that respect to inform the operator of the machine or the driver of a vehicle about the available supply of aqueous urea solution. The tank or container for accommodating that liquid must therefore have a mechanical filling level measuring device or a filling level measuring device of some other kind.

In this connection US No 2005/0284 217 A1 discloses an angular ultrasound measuring apparatus for measuring a filling level in a container, wherein arranged in a lower region of the container in the proximity of the container bottom is a tubular housing portion in which is arranged an ultrasound transmitting/receiving unit. Provided above the angular region is a second housing portion which is arranged substantially perpendicularly to the first housing portion and in which filling level measurement is implemented by way of deflected ultrasound signals. Disposed in the angular region between the first and second housing portions, besides the deflection mirror for the measuring signals, there is also a substantially annular reflector for performing a reference measurement. The entire arrangement is disposed in the liquid, the filling height of which is to be detected. The ultrasound transmitting/receiving unit is connected to an evaluation device by way of suitable lines. The known arrangement thus comprises a multi-part structure with various housing portions in which the liquid to be detected is disposed.

DE 10 2007 059 853 A1 discloses a similar measuring arrangement for measuring a filling level of a liquid in a container, wherein a housing portion which is horizontal in the container bottom and a housing portion perpendicular to the first housing portion are connected by means of an angular region. An ultrasound transducer is arranged in the housing portion arranged horizontally at the container bottom. Disposed outside and within the housing of the measuring apparatus is the liquid whose filling level is to be detected. Within the housing portions the path followed by the ultrasound pulses goes from the signal generating device of the ultrasound transducer to the surface of the liquid and back. The arrangement is in the form of plastic tubes, wherein the housing portions, acting as sound guide members, can also be of a shell-form nature.

DE 10 2009 000 062 A1 discloses a filling level measuring apparatus for determining the filling level of a liquid in a container, wherein a measuring device including an ultrasound transducer is either fitted into a tank in a separate housing so that the liquid to be detected is also disposed in the region of the ultrasound transducer in the separate housing and in a possible calming tube, or an ultrasound transducer of suitable configuration is fitted externally to the tank in the region of the tank bottom at a predetermined location and measurement is implemented in such a way that the ultrasound signals are outputted into the interior of the tank by way of the container bottom. The ultrasound transducer arranged externally on the tank is completely embedded in plastic by that material being suitably injected therearound so that on the one hand the ultrasound transducer is protected and on the other hand easy fitment to the tank bottom is possible.

In detecting a filling level of a liquid or a fluid in the container or tank by means of suitably formed ultrasound signals it is essential for accurate and reliable measurement that the ultrasound signals are introduced into the fluid to be detected with the least possible damping effect so that in that way the ultrasound signal generating unit is adequately coupled to the fluid in regard to the acoustic conditions. Optimum coupling with at the same time simplified structure in respect of such a measuring arrangement is not always guaranteed with the known devices. In particular, in regard to use in motor vehicles with considerable temperature fluctuations occurring in operation and severe vibration, there is a need for a measuring apparatus which irrespective of those considerable additional mechanical and thermal loadings can provide stable and reliable measurement results over a prolonged period of time. That is only guaranteed if good coupling of an ultrasound transducer to the medium to be detected can be maintained over a prolonged period of operation. The arrangements of the known measuring apparatuses, that involve a number of components and a large number of parts cannot always sufficiently ensure such long-term stability so that it must be reckoned that the signals deteriorate in the course of the operating time.

Therefore the object of the present invention is to design a measuring apparatus of the kind set forth in the opening part of this specification for detecting or measuring a filling level in such a way that, in conjunction with a simplified and compact structure and easier fitment, reliable filling level measurement which is stable over a prolonged period of time is guaranteed.

According to the invention that object is attained by a measuring apparatus in accordance with the features of claim 1.

The present invention concerns a measuring apparatus for detecting a filling level of a fluid in a tank by means of ultrasound signals. The measuring apparatus comprises a sensor unit adapted to transmit and receive ultrasound signals, and an evaluation device adapted to evaluate the received ultrasound signals. The sensor unit and the evaluation device are arranged on a common assembly, and the assembly is arranged in a housing of the measuring apparatus.

The arrangement according to the invention of the measuring apparatus according to the features of claim 1 makes it possible to design the measuring apparatus with great long-term stability so that it is possible to obtain reliable measurement (measurement results) with a low level of disturbance over a prolonged period of time even when a considerable loading is involved on the measuring apparatus for example in connection with operation in a motor vehicle. The required long-term stability is acquired with the arrangement according to the invention, whereby effective coupling, that is constant even over a prolonged operating period, of the generated ultrasound signals to the fluid to be detected (medium) is ensured so that there is no need to reckon on increasing signal falsification phenomena (even in part with a creeping onset) during the operating period. Coupling of the ultrasound signals produced in the measuring apparatus to the medium to be detected (fluid) remains stable and reliable so that the desired measuring accuracy is maintained during the service life of the arrangement. In addition accurate measurement of even low filling levels is achieved in that way.

The measuring apparatus also includes a comparatively simple structure and on the one hand it is arranged protected in the housing and on the other hand it is very well coupled to the fluid to be detected, from the acoustic point of view, so that transfer of the ultrasound signals to the fluid and the corresponding echo signals from the fluid to the sensor unit is possible with a very low level of attenuation. The modular structure of the measuring apparatus also ensures that simple fitment with a very low level of complication and expenditure is possible for use of the measuring apparatus in a container filled with fluid.

Further configurations of the present invention are recited in the accompanying appendant claims.

In the measuring apparatus according to the invention the evaluation device and the sensor unit can be arranged on the assembly in mutually adjacent relationship. The assembly can also be fixed elastically in the housing.

The assembly can be supported elastically in the housing by means of at least one carrier element and the sensor unit arranged on the assembly can be pressed elastically against an inside surface of a housing portion of the housing. That promotes good coupling of the sensor unit to the fluid in the tank.

The measuring apparatus can also have a tube portion which is fluid-tightly fixed in the housing and which serves to accommodate feed lines which are electrically connected to the assembly in a connecting region thereof. In addition a reference surface can be arranged on the tube portion at a predetermined spacing relative to the housing to implement reference measurement. The possibility of providing reference measurement affords further information in regard to the properties of the fluid for more accurately determining the transit time of the ultrasound signals in the fluid.

The tube portion of the measuring apparatus can have a connecting device for fixing and sealing the tube portion relative to the tank after the measuring apparatus is fitted into the tank. In that way the measuring apparatus can be easily and securely fixed in sealed relationship.

The sensor unit of the measuring apparatus can be provided for implementing filling level measurement and for emitting ultrasound signals in the direction of the housing and can further be adapted to perform a reference measurement by means of ultrasound signals and to emit the ultrasound signals for reference measurement in the same direction or a different direction therefrom.

A reference reflector can be arranged in the tank in the region of the tank bottom, wherein a reference section extends from the sensor unit to the reference reflector. With the arrangement of the reference reflector in the tank the measuring section for filling level measurement (filling Measuring section) and the measuring section for reference measurement (reference measuring section) can involve different directions.

In the measuring apparatus at least one of the components of the housing or the tube portion can be formed from high-quality steel so that the measuring apparatus components which come into contact with the fluid are extensively protected from corrosion.

In addition the sensor unit can be arranged on an upper side of the assembly and the evaluation device on a lower side of the assembly.

The present invention is described in greater detail hereinafter by means of embodiments by way of example with reference to the drawings in which:

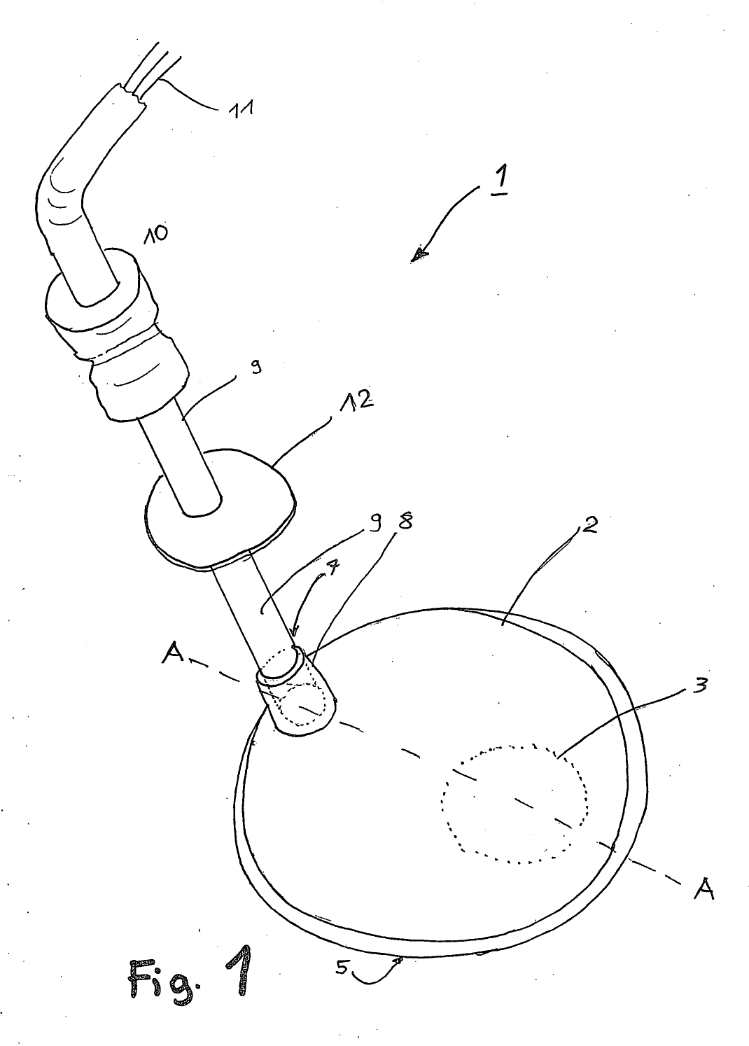

FIG. 1 shows an overall view of the measuring apparatus of the invention in accordance with a first embodiment of the invention,

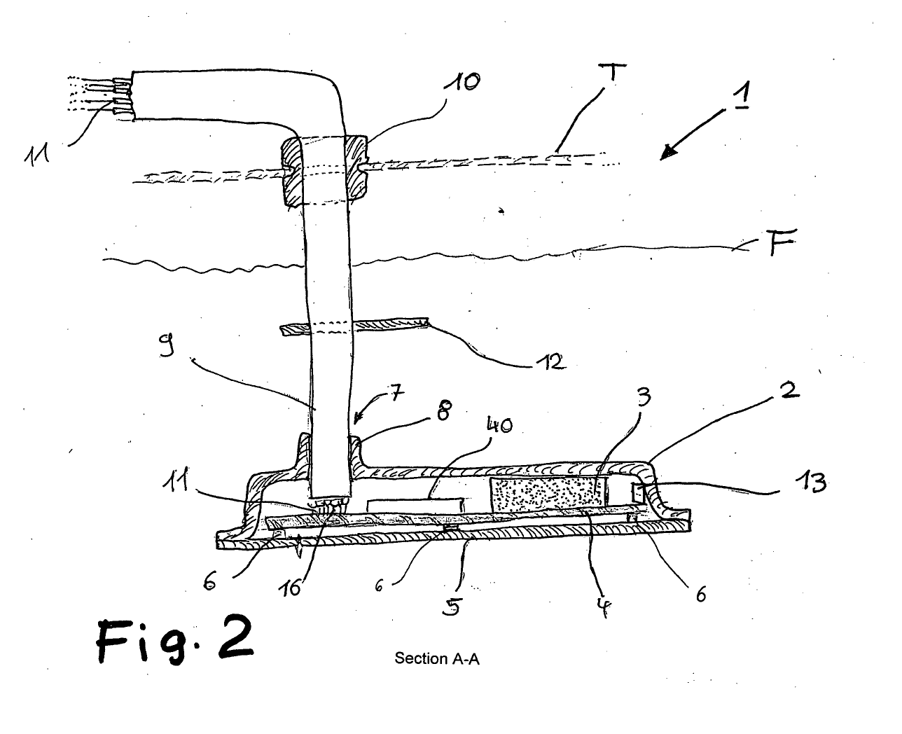

FIG. 2 shows a sectional view of the measuring apparatus of FIG. 1 along section line A-A,

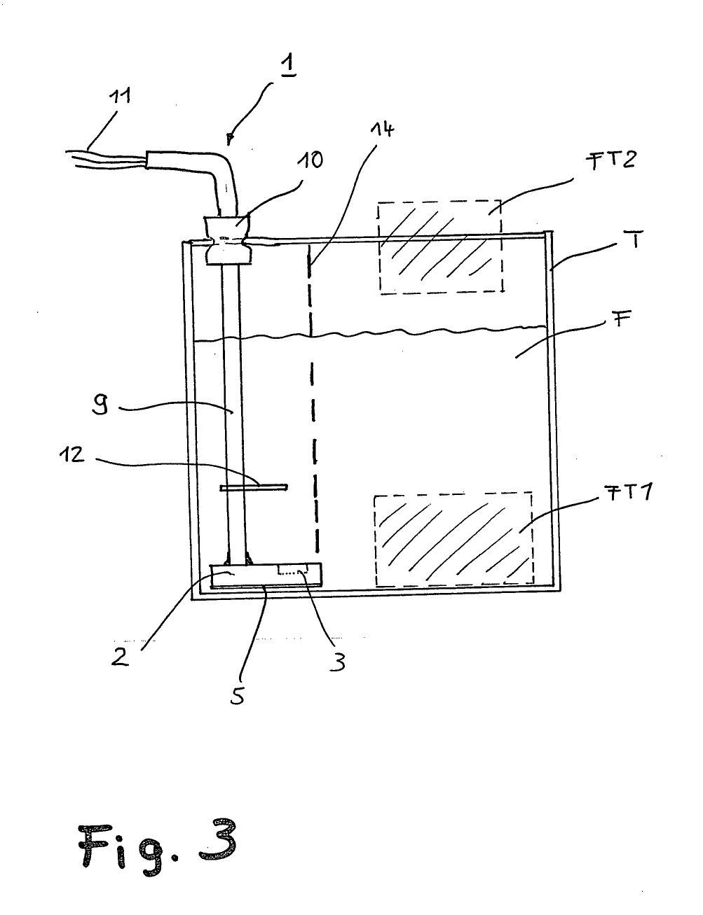

FIG. 3 shows an arrangement of the measuring apparatus according to the invention of FIGS. 1 and 2 in a tank to be detected in respect of its filling level,

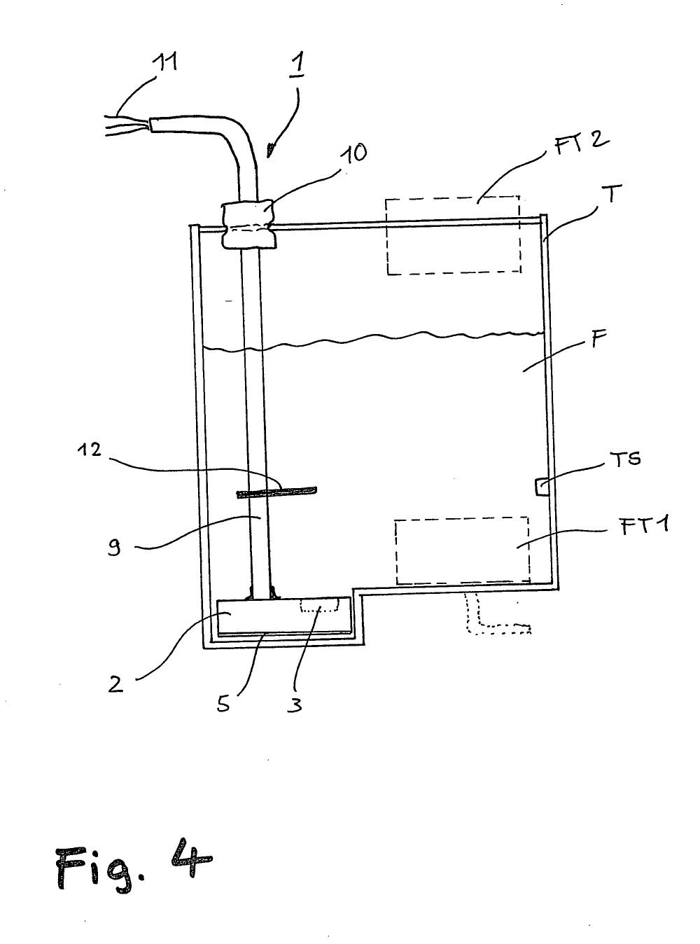

FIG. 4 shows an alternative use of the measuring apparatus of FIGS. 1 and 2 in a tank,

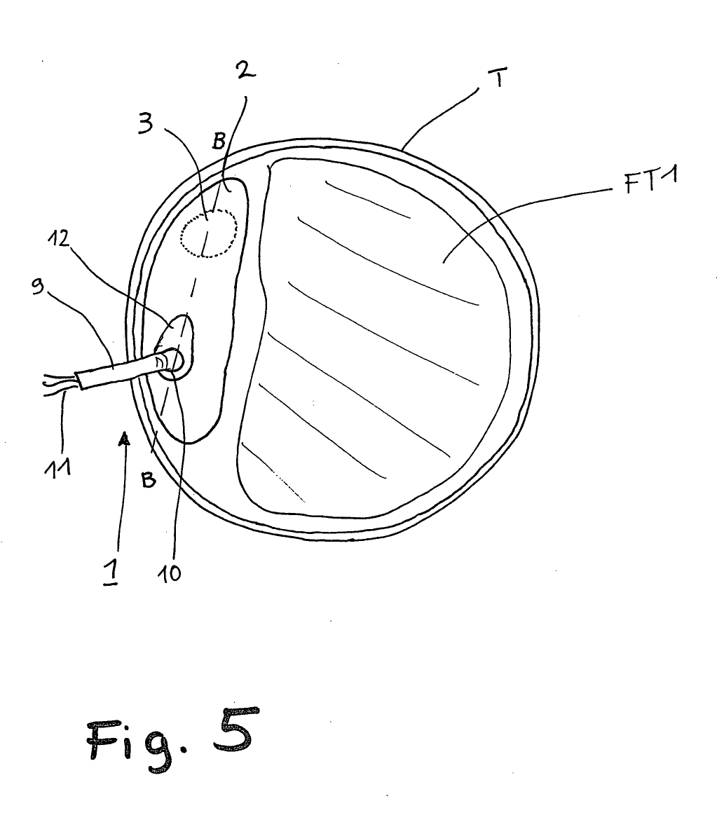

FIG. 5 shows an overall view of the measuring apparatus according to a second embodiment of the invention,

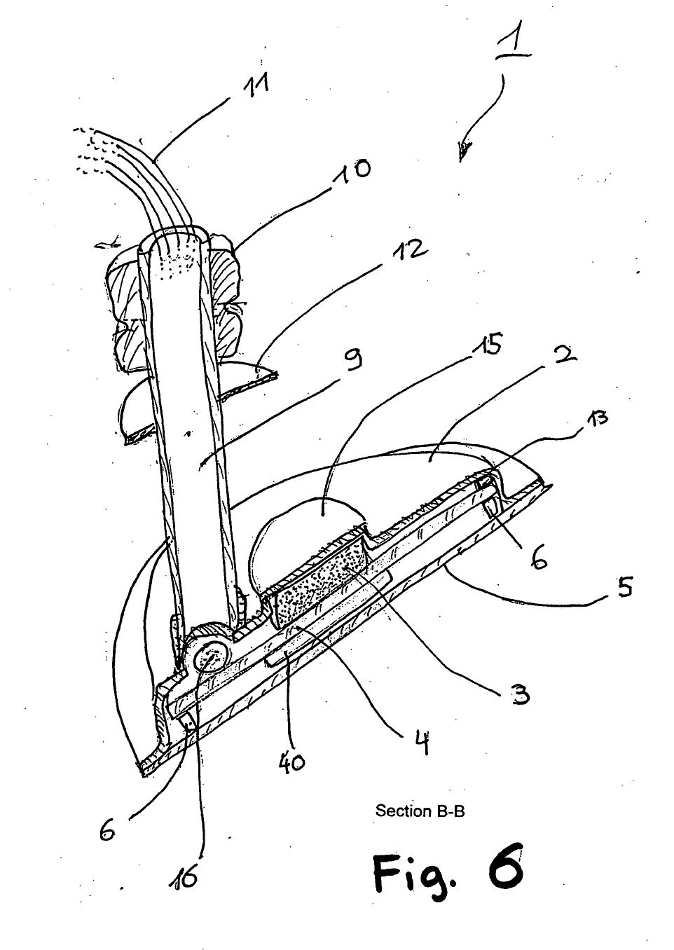

FIG. 6 shows a sectional view of the arrangement of the measuring apparatus of FIG. 5 along section line B-B,

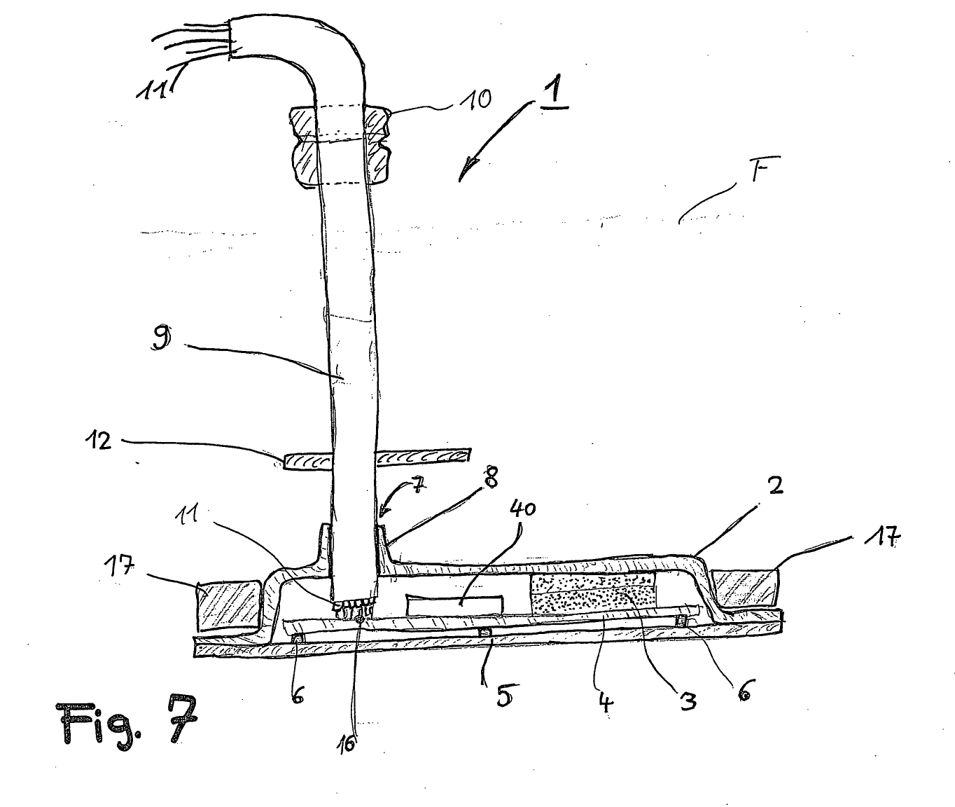

FIG. 7 shows a sectional view of the measuring apparatus according to a third embodiment of the invention in conjunction with a heating device,

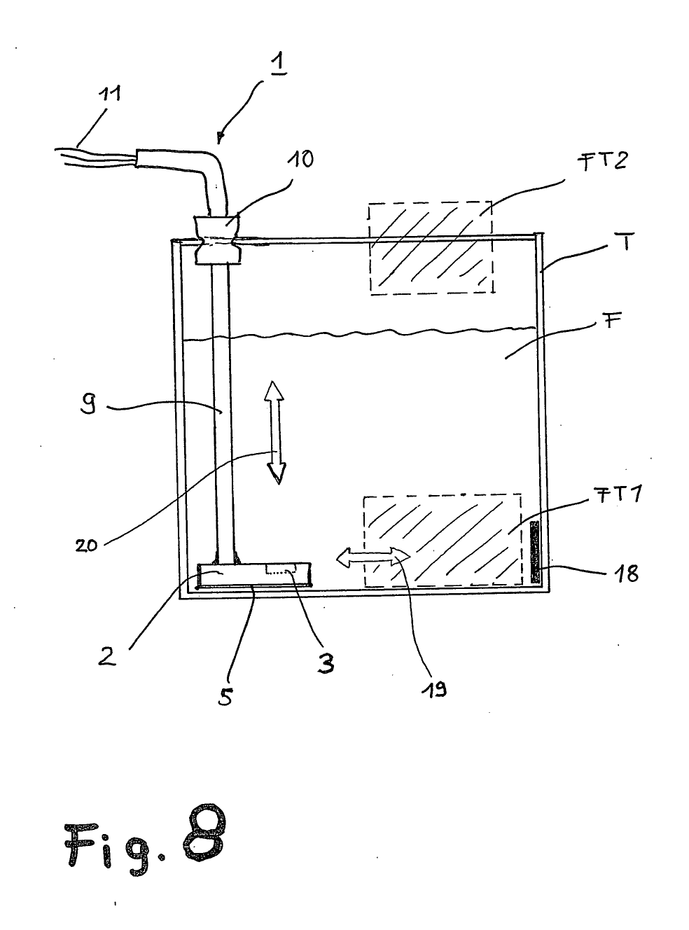

FIG. 8 shows an arrangement of the measuring apparatus according to a fourth embodiment of the invention,

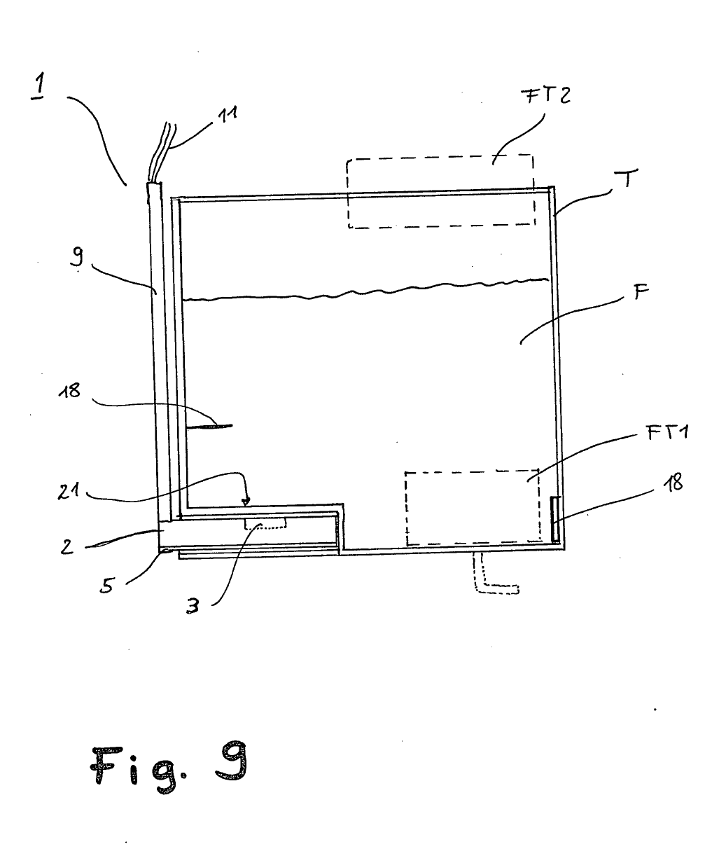

FIG. 9 shows a further use of the measuring apparatus in a tank filled with a fluid, and

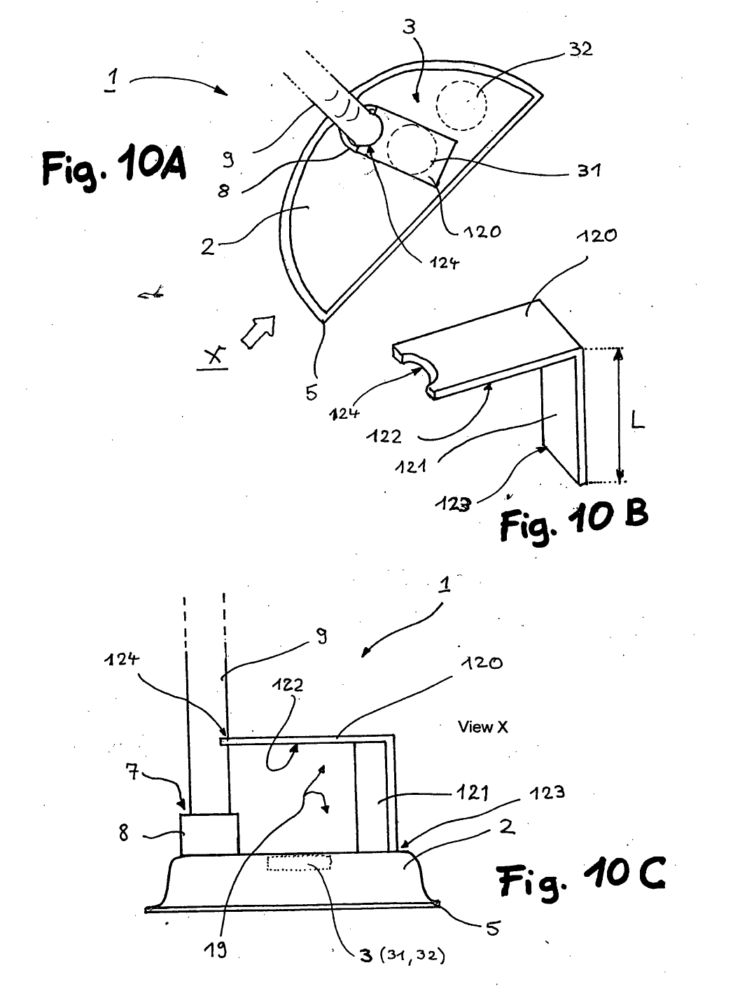

FIG. 10 (FIGS. 10A, 10B and 10C) shows an arrangement of the measuring apparatus according to a fifth embodiment of the invention.

### FIRST EMBODIMENT

The arrangement of a measuring apparatus (filling level detection apparatus) using ultrasound signals is described hereinafter in accordance with a first embodiment by way of example with reference to FIGS. 1 and 2.

FIG. 1 shows an overall perspective view of the measuring apparatus 1, by means of which filling level measurement in a container filled with a fluid F and preferably a liquid can be performed in connection with corresponding ultrasound pulses.

The measuring apparatus includes a main housing or a casing 2 in which an ultrasound transmitting/receiving unit 3 is arranged. The ultrasound transmitting/receiving unit is referred to hereinafter for simplicity as the sensor unit 3. The sensor unit 3 is so designed that on the one hand it can emit ultrasound signals in predetermined directions and on the other hand can receive ultrasound signals, wherein the received signals are reflected signals or echo signals of the ultrasound signals emitted by the sensor unit 3, in regard to determining a given transit time. The sensor unit 3 can be formed from a piezoelectric device or a plurality of piezoelectric devices for generating ultrasound pulses or ultrasound signals. The piezoelectric devices are also referred to as sensor elements. In a sensor unit 3 comprising a plurality of sensor elements they can be arranged at predetermined positions in the housing 2 of the measuring apparatus 1. Preferably therefore the sensor unit 3 with at least one sensor element is used.

FIG. 2 shows a sectional view of the arrangement of the measuring apparatus 1 of FIG. 1 along the section line A-A. The sensor unit 3 (in the present case for example comprising a sensor element) is arranged on an assembly 4 in the view in FIG. 2 and is electrically and functionally connected to further electric or electronic components (not shown) of the assembly 4. In the assembly 4 shown in FIG. 2 the electric or electronic components can be arranged on the topside and/or the underside of the assembly 4 and form a circuit arrangement which can also perform evaluation of received ultrasound signals (echo signals). In any case the assembly 4 and the sensor unit 3 are arranged within the housing 2 and preferably fixed on a bottom portion 5. The fixing is such that on the one hand it ensures secure fixing and positioning of the assembly 4 including the sensor unit 3 and that the assembly 4 is fixed on the bottom portion 5 with a certain damping attenuation and therefore with a predetermined elasticity. FIG. 2 shows carrier elements 6 for fixing the assembly 4 on the bottom portion 5, wherein the present invention is not limited either to the number of carrier elements 6 or to the arrangement and configuration thereof. The housing 2 in conjunction with the bottom portion 5 represents a closed housing or overall housing. For that purpose the bottom portion 5 is fixed on the housing 2 in sealed relationship (fluid-tightly).

As shown in FIG. 2 disposed in the housing 2 is an opening region 7 having a collar 8 in which a tube portion 9 is arranged or fitted. The opening region 7 in the housing 2 in the region of the collar 8 is of such a configuration that the tube portion 9 is fitted flush into the collar 8, in respect of cross-sectional area and shape so that complete sealing integrity is produced between the collar 8 and the tube portion 9. Sealing integrity can also include separate sealing elements (not shown) fitted between the collar 8 and the tube portion 9. The sealing integrity is essentially sealing integrity in relation to moisture penetrating thereinto and other liquids as well as in respect of unwanted escape of the fluid from the tank T.

The tube portion 9 can issue from the housing 2 in conjunction with the opening region 7 and the collar 8 at any angle, an exit angle of between 70° and 110° being preferred. Those angles are measured between a notional axis along the extent of the tube portion 9 relative to the surface of the housing 2 and/or the bottom portion 5 and thus in relation to a notional horizontal line along the upper surface of the housing 2. The view in FIG. 2 shows an angle arrangement of substantially 90°.

In its upper portion remote from the housing 2 the tube portion 9 can further be of an angled configuration at any angle, insofar as that is necessary, and in the upper region the tube portion 9 includes a connecting unit 10 which forms a connection between an upper region of the tank T into which the measuring apparatus 1 is fitted and the tube portion 9. The connecting unit 10 thus provides on the one hand for securing and fixing the tube portion 9 in a suitable through opening in an upper wall of the tank T, while on the other hand it affords sealing integrity in relation to foreign substances penetrating into the tank and fluid issuing from the tank T at that location.

Above the connecting unit 10 shown in the views in FIGS. 1 and 2 the tube portion 9 can be of an angled configuration in any fashion and in dependence on the conditions of installation both of the tube portion 9 in the tank T and also of the tank T in a piece of equipment.

Essentially feed lines 11 are passed in the tube portion 9 to the assembly 4 in any number and of differing kinds. The tube portion 9 is thus suitable for protecting the feed lines 11 within the tube portion 9 in relation to extraneous influences from outside.

As shown in FIG. 2 the lines 11 are shown in their passage to the assembly 4. The lines 11 include data lines and power supply lines (current supply lines) for operation of the circuit arrangement embodied on the assembly 4 (the circuit arrangement serving as an evaluation device 40) as well as the sensor unit 3 and for feeding and carrying away data, instructions and measurement results on individual lines or also in bidirectional form. The feed lines 11 are connected outside the tank T into which the measuring apparatus 1 is fitted to a corresponding external processing device (general EDP installation, control computer of a piece of equipment, PC or host computer) and also an associated power supply device.

The tank T whose filling level of fluid F is to be measured is indicated in FIG. 2 by broken lines in the region of the connecting unit 10.

When the measuring apparatus 1 of the above-described structure and in accordance with the first embodiment is fitted into the tank T then actuation of the circuit arrangement of the evaluation device 40 on the assembly 4 and operation of the sensor unit 3 is implemented by way of the feed lines 11. In that case the sensor unit 3 sends ultrasound signals preferably upwardly in FIG. 2 in the direction of the fluid F within the tank T and further detects the corresponding echo signals. The filling level of the fluid F (corresponds to the filling height in the tank T) can be determined in dependence on the speed of sound within the fluid F and the detected transit time. The filling volume of fluid F in the tank T is inferred from that geometrical parameter in the evaluation unit 40 or the external processing device (not shown) which is connected by way of the feed lines 11, in accordance with stored data (which also take account of an irregular shape of the tank T. The transit time represents a period of time between a produced and emitted ultrasound pulse and reception of the ultrasound pulse (echo signal).

The arrangement of the measuring apparatus 1 shown in FIG. 2 further shows a reference surface 12 arranged at a predetermined location on the tube portion 9 above the housing 2. The reference surface 12 at a predetermined (known) spacing relative to the sensor unit 3 serves essentially, when detecting the desired filling volume of the tank (filling quantity), to reduce interference influences such as for example due to temperature and/or pressure of the fluid F, or to permit complete compensation of such interference influences. Sound pulses reflected at the reference surface 12 can be referred to as a reference pulse or reference echo, with which a known transit time can be associated, in conjunction with the temperature and pressure of the fluid F. In dependence on data stored in the processing device (not shown), it is possible to infer the speed of sound in the fluid F, which depends on density, temperature and in this connection also pressure of the fluid F in the tank T. A reference measurement can thus be implemented by means of the reference surface 12, wherein the accuracy of determining the filling volume or the filling level of the fluid F in the tank T can be considerably increased, in conjunction with the result of the reference measurement.

For detecting the temperature of the fluid F a temperature sensor 13 is provided in or on the housing 2, the sensor performing corresponding temperature detection. The detected temperature information is fed to the evaluation device 40 on the assembly 4. Further temperature sensors can also be arranged for example on the tube portion 9 or can be disposed at other locations in the tank T so that with an unequal temperature distribution of the fluid in the tank T, detailed temperature detection can also be effected and if required a suitable mean value can also be formed.

FIGS. 3 and 4 show the arrangement of the measuring apparatus 1 after fitment in the tank T.

Referring to FIG. 3 the measuring apparatus 1 is disposed in the tank T in such a way that the housing 2 rests with the associated bottom portion 5 preferably in the bottom region of the tank T or is disposed in the proximity thereof so that the sensor unit 3 emits the required ultrasound pulses as shown in FIGS. 3 and 4 upwardly in the direction of the fluid F and also receives therefrom corresponding reflection signals (echo signals).

In both of FIGS. 3 and 4 the tube portion 9 is mechanically fixed by means of the connecting unit 10 in the upper part of the tank T (in the cover region of the tank T) and sealed off at the same time. The measuring apparatus 1 can be easily fitted into the tank T, in which case it is only necessary to ensure fixing and sealing in connection with the connecting unit 10.

In the arrangement shown in FIG. 4 the measuring apparatus 1 is fitted in such a way that the housing 2 is disposed with the bottom portion in a recess 14 of the tank T so that it is possible to detect even small filling heights of the fluid F. In other respects the arrangement is similar to that in FIG. 3.

In bottom cases of the views in FIGS. 3 and 4 moreover a first and a second functional region FT1 and FT2 are indicated by hatched blocks. The first functional region FT1 in both of FIGS. 3 and 4 illustrates in simplified form devices provided for possibly heating the fluid F in the tank T and for providing an outlet device in the lower part of the tank T and depending on requirements with corresponding valves and filter devices. The first functional region FT1 thus denotes the possibility of arranging an outlet region with take-off tubes in the lower region of the tank T while the second functional region FT2 is arranged in the upper part of the tank T and shows for example a possible way of taking off the fluid F upwardly out of the tank T by way of riser tubes. Filter devices and pumps and valves required for taking off the fluid F can also be provided here.

FIG. 3 also provides an arrangement of the measuring device 1 in which an inner housing 14 which is partly separate from the rest of the volume of the tank T is arranged in the tank T. The inner housing 14 is indicated by broken lines. That inner housing 14 can be provided for producing a special region in the tank T, in which the measurement is implemented. The inner housing 14 is connected to the further volume of the tank in the manner of communicating tubes. In that respect there can be the advantage that a calming region is formed in the tank T in respect of the measurement volume so that, upon movements of the piece of equipment in which the tank T is arranged, such as for example in a motor vehicle, the influence of the fluid F sloshing around on the level of measuring accuracy is reduced. The present invention however is not limited thereto but measurement can also be effected without the provision of the inner housing 14 of FIG. 3.

FIG. 4 therefore shows by way of example the arrangement of the tank T without inner housing 14 so that it is possible to achieve a simplification in the overall structure of the tank T and thus also fitment of the measuring apparatus 1. Reference TS denotes a possible further temperature sensor arranged in the tank T independently of the measuring apparatus. The detection result is fed to the evaluation device 40 for further processing. In the FIG. 4 view the measuring apparatus 1 is fitted into the tank T in such a way that the housing 2 is arranged in a recess in the bottom of the tank T. In that way even very small amounts of fluid within the tank T can be reliably detected. In addition, besides fixing of the tube portion 9 by means of the connecting device 10 in the upper region of the tank T, there is also a positively locking relationship for the housing 2 with the recess in the tank bottom so as to ensure very secure fixing of the measuring apparatus 1.

### SECOND EMBODIMENT

FIG. 5 shows a perspective view of a region of the tank T in which the measuring apparatus 1 of the second embodiment of the present invention is used. In the present second embodiment the measuring apparatus 1 is of a similar form to that described in relation to FIGS. 1 and 2. The measuring apparatus 1 of the second embodiment can be fitted into the tank T in the same way as shown in FIGS. 3 and 4. Unlike the arrangement of FIGS. 1 and 2 the measuring apparatus 1 of the second embodiment of FIG. 5 is smaller and is of different proportions and a different shape. As an example of a configuration of the tank T, to which the present invention however is not restricted, the tank bottom (in the plan view in FIG. 5) is approximately circular. Thus in regard to its appropriate form the measuring apparatus 1 of the second embodiment occupies a part of the base surface or bottom surface of the tank T. The further base surface area of the tank T, that is not occupied by the measuring apparatus 1, can for example accommodate the first functional region FT1, wherein that can accommodate the components already specified hereinbefore for taking off the fluid F downwardly, such as for example filter devices, pumps, valves and conduits. In that case the functional region can extend over the entire remaining part of the tank bottom or only over a portion thereof.

The apparatus 1 of the second embodiment also includes the sensor unit 3 (with at least one sensor element) which is preferably arranged at one side of the housing 2 and has at least one sensor element. In the FIG. 5 view the emission direction and the reception direction are in the direction of view of the person viewing the drawing. The further structure of the measuring apparatus 1 is similar to that of the first embodiment. The sensor unit 3 is also arranged on the assembly 4 which is mounted elastically by means of the carrier elements 6 and further carries the components of the evaluation device 40. In FIG. 5 the evaluation device 40 is arranged by way of example on the underside of the assembly 4.

With the arrangement of FIG. 5 there is also the possibility of the sensor unit 3 being able to perform a measurement operation in conjunction with a separate inner housing 14 (see also FIG. 3), but that is not necessary and the invention is not restricted thereto.

FIG. 6 shows a sectional view of the measuring apparatus 1 of the second embodiment along a section line B-B as is shown in FIG. 5. The structure is substantially the same as in the FIG. 2 view of the first embodiment, but here the housing 2 additionally has a curvature 15, beneath which the sensor unit 3 is arranged on the assembly 4. The sensor unit 3 rests flush on the housing 2 and in particular in the region of the curvature portion 15 of the housing 2 and therefore can optimally receive the emitted and reflected ultrasound pulses, with at the same time a low level of damping. The arrangement shown in FIG. 6 leads to very good coupling of the sensor unit 3 to the housing 2 and thus also to the fluid F which is above the housing 2 and the curvature portion 15.

FIG. 6 in connection with the perspective sectional view in the upper region of the tube portion 9 shows the feed lines 11 and, at the lower end of the tube portion 9, on the assembly 4, a connecting region 16. In the connecting region 16 of the assembly 4 the lines 11 are connected to the evaluation device 40 arranged on the assembly 4. The sensor unit 3 is fixed directly on the assembly 4 and thus has very short connections to the circuit arrangement arranged on the assembly 4, with electric and electronic components of the evaluation device 40. The assembly 4 can also carry the temperature sensor 13, but this can also be operatively arranged in other regions of the housing 2 or also outside same in the tank T.

The mode of operation of the measuring apparatus 1 of the second embodiment in FIGS. 5 and 6 is the same as that of the first embodiment so that repetitions are dispensed with. In the same manner as in the first embodiment the measuring apparatus 1 includes the reference surface 12 and the connecting unit 10 arranged on the tube portion 9 for fixing the measuring apparatus 1 in the tank T which is not shown in FIGS. 5 and 6.

The circuit arrangement in connection with the associated components of the evaluation device 40 can be arranged as shown in FIG. 6 above and/or below the assembly 4, wherein the assembly 4 is supported or carried by means of the carrier elements 6 already shown in FIG. 2 within the housing 2 and also in relation to the bottom portion 5. That supporting action is provided with a certain elasticity to avoid fractures of the assembly 4 and the sensor unit 3 in the event of vibration. Equally the sensor unit 3 bears against the inner wall of the curvature portion 15 of the housing 2 in an elastic and thus predetermined relationship so that the desired optimized coupling for transmitting and receiving the respective ultrasound signals (pulses) is guaranteed. The sensor unit 3 is shown as being substantially circular to simplify the view in the Figures (for example FIGS. 1 and 5). The invention however is not restricted to that arrangement as the sensor unit 3 can be of any suitable shape.

### THIRD EMBODIMENT

FIG. 7 shows the arrangement of the measuring apparatus 1 of the third embodiment, wherein the basic arrangement is the same as that of FIG. 2 of the first embodiment. The sensor unit 3 (with at least one sensor element) is disposed on the assembly 4 which is supported on the bottom portion 5 by means of the carrier elements 6 so that the sensor unit 3 bears against the inside wall of the housing. The measuring apparatus 1 also includes the tube portion 9 with the reference surface 12 arranged thereon and the connecting unit 10. The feed lines 11 which are connected to the assembly 4 in the connecting region 16 extend in the tube portion 9.

Supplemental to the arrangement of FIGS. 1 and 2 in connection with the first embodiment and in comparison with the second embodiment the measuring apparatus 1 includes a heating device 17 which surrounds the housing 2 in a ring or partial ring shape. The heating device 17 can also receive its electric power by way of the feed lines 11 and serves to bring the fluid F in which the overall arrangement of the measuring apparatus 1 is disposed to a predetermined temperature or to attain a minimum temperature. For example the heating device 17 can serve, when detecting the filling level of a tank with urea for exhaust gas cleaning, to prevent freezing of the urea solution at low ambient temperatures or to ensure that it thaws again after it has frozen. In connection with suitable temperature sensors (not shown) the need for heating power can be controlled or regulated and measurement can also be controlled in dependence on the degree of liquefaction of the frozen fluid.

### FOURTH EMBODIMENT

FIG. 8 shows in simplified and diagrammatic form a further embodiment of the measuring apparatus 1 according to the present invention. The basic structure of the measuring apparatus 1 is the same as that of the first and second embodiments, but unlike those embodiments the tube portion 9 does not have a reference surface (measuring surface) 12. In comparison with the first and second embodiments the reference surface in the form of a reference reflector 18 is arranged not on the tube portion 9 but in a region of the tank T, wherein a reference measuring section 19 is formed in conjunction with a corresponding arrangement of the housing 2 of the measuring apparatus 1. The reference reflector 18 is preferably arranged in a lower part of the tank T so that the reference measuring section 19 is arranged substantially horizontally in this arrangement. It is possible in that way to perform reliable measurement even with low filling levels of the fluid F in the tank T as reference measurement is also guaranteed at low filling levels and with a small filling amount. Further measurement is effected by way of a filling measuring section 20 in accordance with the arrows in FIG. 8, by means of which the emitted and reflected ultrasound signals are indicated in simplified diagrammatic form.

Reference measurement and filling level measurement are therefore effected in different directions, in which respect the sensor unit 3 (with at least one sensor element) can be in the form of two sensor devices which emit and receive in different directions. In addition, with only one sensor device in the sensor unit 3, a part of the emitted ultrasound signals can be diverted in the direction of the reference measuring section 19 by means of a further deflection reflector (not shown), in which respect that also applies to the respective echo signals so that reference measurement can also be effected in conjunction with filling level measurement. Suitable evaluation of the different echo signals in the evaluation device 40 on the assembly 4 and/or in a connected computer is required.

In that way it is possible to dispense with the reference surface 12 on the tube portion 9 (for example FIGS. 1, 2 and 7) and with the arrangement of the measuring apparatus 1 in accordance with the third embodiment and the view in FIG. 8 it is possible to perform both reference measurement and also filling level measurement, even with small amounts of fluid remaining in the tank T. With the possibility of reference measurement, the desired high level of measurement accuracy can be maintained even with very small amounts of fluid.

Referring to FIG. 8 there is the possibility of the reference reflector 18 being arranged as the reference surface in the proximity of the tank bottom, in conjunction with the first functional region Fri shown in FIGS. 3 and 4.

FIG. 9 shows an alternative arrangement of the measuring apparatus 1 in accordance with the fourth embodiment of the invention, with the measuring apparatus 1 being arranged outside the tank T. The measuring apparatus 1 is thus not disposed in the tank T but is arranged outside the tank in a certain region in close contact with the tank T. In particular the housing 2 with the sensor unit 3 is so arranged in the tank 1 in a recess in the tank T that good contact between the housing 2 and a bottom surface 21, which is thereabove, of the tank T is guaranteed and the sensor unit 3 can emit ultrasound signals into the interior of the tank T and can receive the echo signals from there. In that respect the structure of the measuring apparatus 1 can be the same as that which is shown for example in connection with the first embodiment in FIGS. 1 and 2. As a difference in relation thereto however the reference reflector 18 is arranged within the tank T or it can be arranged in a similar manner as shown in FIG. 8, having regard to the approximately horizontal reference measuring section 19, in the region of the first functional region FT1 so that the directions of the measuring operations and reference measurement are different.

The arrangement in FIG. 9 makes it possible to dispense with further sealing measures which are required when fitting the measuring apparatus 1 into the tank as shown in FIGS. 1 through 8. At any event it is necessary to ensure that coupling of the housing 2 with the sensor unit 3 to the bottom surface 21 of the tank T in acoustically advantageous fashion is optimized for avoiding an unwanted damping effect. The bottom surface 21 of the tank T, which as shown in FIG. 9 is arranged over the housing 2 of the measuring apparatus 1, must be capable of ensuring good coupling between the housing 2, the sensor unit 3 and the fluid F, even over a prolonged service life for the entire arrangement. The material of the bottom surface 21 above the housing 2 of the sensor unit 3 is to be suitably stable in respect of shape in order also to guarantee the required coupling effect. There is also the possibility of arranging a suitable material for improving the coupling effect between the surface of the housing 2 and the underneath of the bottom surface 21 of the tank 1.

In the view in FIG. 9 the reference surface 12 is arranged at a predetermined height and position within the tank 1. The present invention however is not restricted thereto and the reference surface 12 can also be arranged in the region of the tank bottom in the proximity for example of the first functional region FT1 in the form of the reference reflector 18, as already indicated in FIG. 8.

### FIFTH EMBODIMENT

FIG. 10 consisting of FIGS. 10A, 10B and 10C shows an arrangement of the measuring apparatus 1 in accordance with a fifth embodiment of the invention.

The measuring apparatus 1 of the fifth embodiment as shown in FIG. 10A is of a similar structure to the measuring apparatus 1 of FIG. 5 of the second embodiment. In the fifth embodiment the sensor unit 3 comprises a plurality of sensor elements. In the present case and as shown in FIG. 10A there are for example two sensor elements in the form of a first sensor element 31 and a second sensor element 32. The two sensor elements 31 and 32 can be similar or also different in regard to their structure.

The first sensor element 31 of the sensor unit 3 of the measuring apparatus 1 is arranged closer to the tube portion 9 and is disposed under a substantially angularly arranged reflection element 120. The reflection element 120 which can be in one piece or of a multi-part structure includes a side element 121 extending substantially perpendicularly to the surface of the housing 2 and a reflection portion 122 extending substantially parallel to the surface of the housing 2. The free end of the side element 121 is connected to the housing 2 at a first location 123 and the free end of the reflection portion 122 is connected to the tube portion 9 at a second location 124. In this respect connecting options can be implemented by welding, soldering or adhesive or by further suitable connecting options.

The first sensor element 31 of the sensor unit 3 is disposed within the housing 2 and beneath the reflection element 120 so that ultrasound signals emitted by the first sensor element 31 can be reflected at the reflection portion 122 and received in the first sensor element 31. The corresponding detection signals can be evaluated. Operation of the first sensor element 31 serves for reference measurement with further evaluation options as the reflection portion 122 is disposed at predetermined spacing L (see FIG. 10B) from the first sensor element 31 or the upper surface of the housing 2. That is also shown in FIG. 10C which represents a side view viewing in the direction of view indicated by the arrow X in FIG. 10A. A reference measuring section 19 (FIG. 10C) is provided between the reflection element 120 (reflection portion 122) and the upper surface of the housing 2.

In conjunction with the known distance L between the first sensor element 31 and the reflection portion 122, it is also possible to ascertain properties of the fluid F therebetween. That can be effected relative to already stored data.

In the view in FIG. 10A the second sensor element 32 of the sensor unit 3 is arranged further away from the tube portion 9 and is also disposed at a given spacing relative to the reflection element 120 so that ultrasound signals emitted by the second sensor element 32 are not reflected by the reflection portion 122 or are so reflected only to an immaterial degree, but are delivered directly into the fluid F thereabove for detecting the filling level or the filling height.

Thus on the one hand the first sensor element 31 of the sensor unit 3 serves for reference measurement while on the other hand the second sensor element 32 serves for actual filling level measurement.

Free spaces within the housing 2 in conjunction with the bottom portion 5 can be occupied by electronic circuits for actuation of the sensor elements 31 and 32 and for the evaluation of sensor signals. A heating device can also be provided if required.

In the same manner as shown in FIGS. 2, 6 and 7 the individual sensor elements 31 and 32 of the sensor unit 3 can be disposed on an assembly like the assembly 4, wherein the for example two sensor elements 31 and 32 bear against the lower (inner) surface of the housing 2 to ensure an acoustic connection. The individual sensor elements can in that case be pressed against the lower surface of the housing 2 or it is possible to produce a connection involving intimate joining of the substances concerned by means for example of an adhesive.

The above-described arrangement of the reflection element 120 ensures that, even upon use in a motor vehicle with severe temperature fluctuations and an increased loading in relation to vibrations, the reflection element 120 remains fixedly at the associated position so that reliable reference measurement is possible in connection with the reflection portion 122 even over a prolonged period of operation. Increased accuracy and reliability of reference measurement is thus guaranteed even over a prolonged service life for the entire measuring apparatus 1.

Moreover the arrangement of the fifth embodiment achieves basically the same advantages as those of the above-described embodiments.

Further Modifications

In the present invention and in connection with the above-described embodiments the tube portion 9 serves as a holding device and also for accommodating feed lines 11 (connecting lines) so that especially when the measuring apparatus 1 is fitted into the tank T the lines 11 (connecting lines, cables) can be passed within the tube portion 9. The reference surface 12 can be arranged on the tube portion 9 in the straight region thereof at a predetermined height relative to the arrangement of the sensor unit 3 so that this provides a reference section, the detection of which permits evaluation in respect of actual properties of the fluid F. There is the possibility of arranging a further heating device flat in the outer region of the tube portion 9 as shown in FIGS. 1 through 8, which further heating device can be provided additionally to or alternatively to the heating device 17 shown in FIG. 7. In that case the further heating devices can be provided as a unit which is to be operated independently, in which respect however regulation or at least control of the heating power output and also the switch-on times of the heating device is also possible in connection with a measured filling level.

Upon evaluation of the echo signals which are received by means of the sensor unit 3 in its function as transmitter and receiver, a transit time, the signal form, an amplitude and the damping characteristics are taken into account. The actual temperature of the fluid F in the tank T is also taken into consideration.

In regard to the foregoing representation of the tube portion 9 it is stated that the feed lines 11 extend in the tube portion 9 and are thereby protected from influences from the outside. The tube portion 9 is sealed off in relation to the penetration of fluid F thereinto. In comparison however, in the case of suitably protected individual feed lines 11, the tube portion 9 can also be filled with the fluid F in the manner of communicating tubes. Sealing integrity is also required in relation to the interior of the housing 4 including the bottom portion 5. The function of the sensor unit 3 is also unaltered in that case in the manner as is described hereinbefore.

In accordance with the above-described embodiments measurement of the transit time of the ultrasound signals of the sensor unit 3 is effected in a substantially vertical direction from below upwardly. That is also the case in regard to reference measurement by means of the arrangement of for example FIG. 2 and the reference surface 12 at a predetermined height over the sensor unit 3 and, as a departure from the view in FIGS. 8 and 9, in connection with the reference measuring section 19.

As shown for example in FIGS. 2, 6 and 7 the reference surface 12 can be in the form of an annular metal element (steel element) disposed at a predetermined spacing relative to the sensor unit 3 and also relative to the upper surface of the housing 2. Despite its arrangement on the measuring apparatus 1 or elsewhere in the tank T the reference reflector 18 or the reference surface 12 can be part of the measuring apparatus 1. In accordance with the fifth embodiment a reference surface can be formed with the reflection element 120, in which case, in the event of a multi-part sensor unit 3, a sensor element (for example the first sensor unit 31) is arranged under the substantially angular reflection element 120 for performing the reference measurement.

Within the housing 2 the sensor unit 3 with the at least one sensor element is preferably arranged on the assembly 4. The assembly 4 thus carries the sensor unit 3 and there are also the electric and data connections. The assembly 4 is supported by means of the carrier elements 6 shown by way of example in FIG. 2, in which respect on the one hand they are fixed and on the other hand are also supported elastically to a predetermined degree so that the sensor unit 3 arranged on the assembly 4, in conjunction with that elastic mounting, is pressed securely against the underside of the housing 2. That permits good coupling of the sound generator in the sensor unit 3 to the fluid F by optimum sound conduction from the sensor unit 3 to the fluid F. A slight level of damping occurs in that case.

The housing 2 and the tube portion 9 as well as the bottom portion 5 can comprise a strong and suitably tough plastic which is stable in respect of shape. Preferably the housing 2, the bottom portion 5 and the tube portion 9 are formed from a strong metal material such as for example high-quality steel so that acoustic coupling to the fluid F is also improved by that choice of material. The metal or high-quality steel housing affords great protection from a mechanical point of view and is also corrosion-resistant in relation to the corresponding fluids. In the case of the tube portion 9 the upper part which projects out of the tank T (above the connecting device 10) can also comprise another suitable material such as for example a plastic. In that respect the metal thickness can be in the range of between about 1 and 5 mm or preferably between 2 and 4 mm, in which case good acoustic coupling can be achieved.

Arranged in the upper region of the tube portion 9 is the connecting unit 10, by means of which on the one hand the tube portion 9 and thus also the entire measuring apparatus 1 is mechanically held fast and fixed after being fitted into the tank T, and sealing integrity is also achieved in relation to fluid F escaping from the tank T. In particular the connecting unit 10 is of such a design configuration that it is provided along a predetermined length in the direction in which the straight part of the tube portion 9 extends, and the connecting unit 10 comprises a material, for example a tough plastic, which performs the sealing function and at the same time has adequate mechanical strength. In particular the connecting unit 10 bears flush and over a large surface area against the outer surface of the tube portion 9 so that, in the event of longitudinal displacement of the tube portion 9 in the connecting device 10 (for example during assembly or also for tolerance compensation in the case of different temperatures), the function of sealing integrity is maintained. Thus in spite of the possibility of longitudinal displacement of the tube portion 9 in the connecting unit 10, sealing integrity in relation to issuing fluid is maintained (fluid-tight). The sealing integrity is also effective in relation to foreign substances being able to penetrate into the tank T from the outside.

With the arrangement according to the invention of the sensor unit 3 on the assembly 4 and the fact that the sensor unit 3 is pressed elastically against the underside of the housing 2 (in FIG. 6 also against the curvature portion 15) the desired good coupling to the fluid F from the acoustic point of view is achieved. Arranging the sensor unit 3 on the assembly however also leads to very short line paths between the circuit arrangement of the evaluation device 40, that is arranged on the assembly 4, and the sensor unit 3. With the sensor unit 3 and therewith the ultrasound producing elements and ultrasound receiving elements contained therein being arranged very close to the electronic circuit of the evaluation device 40 for the received signals and for controlling the emitted ultrasound signals, the short line connections provide for short transit times for the signals on the corresponding line connections within and to the assembly 4 so that, particularly in the reference measurement in relation to the reference surface 12 or the reference reflector 18, with short travel paths, the risk of disturbances or signal falsification is considerably less. This arrangement also has a highly advantageous effect on the signal transit time on the assembly 4 so that the degree of accuracy of measurement is considerably promoted with this arrangement. For that purpose the evaluation device 40 can be arranged on the top side and/or the underside of the assembly 4. In any case the evaluation device 40 is arranged near the sensor unit 3.

In addition it is possible to achieve a compact design configuration for the overall measuring apparatus 1. The measuring apparatus 1 can thus be constructed in the form of a measuring module which can be fitted into a large number of design configurations of a tank T. In particular the variant shown in the view in FIG. 5, which is smaller in its dimensions, is suitable for also being used in a tank T of a small volume.

The short line paths between the electronic circuit arrangement of the evaluation device 40 on the assembly 4 and the sensor unit 3 (also in conjunction with the connecting regions 16 of the lines 11) ensures the advantages in relation to a low level of signal falsification and an optimized signal-to-noise ratio (advantageous S/N characteristics) due to the short transit times achieved on the short line connections. Even short transit times for the ultrasound signals in the measurement procedure in particular when a low level of the fluid F in the tank T is involved can be accurately detected. Thus the reference measuring section 19 can be kept small, in connection with the reference reflector 18 or the reference surface 12.

The evaluation device 40 includes an electronic circuit arrangement and serves for evaluation and processing of signals of any kind, for the storage of data and programs, for the control or regulation of processes, for power or energy supply, possibly with regulation, and for time control of processes. It also forms an interface outwardly to a connected computer. The assembly can comprise one or more interconnected printed circuit boards or cards and accommodate the multiplicity of components.

In addition the sensor unit 3 is protected from vibration in accordance with the mounting which is elastic in a predetermined fashion and in conjunction with the assembly 4 and the carrier elements 6 so that particularly in the case of a sensor unit 3 based on a piezoceramic it is possible to expect a long service life.

The modular structure and the corresponding arrangement of the sensor unit 3 on the circuit board 4 supported by the carrier elements 6 and the arrangement of those components in the housing 2 which is closed off by the bottom portion 5 permits the compact structure, good coupling to the fluid F and, due to the short line paths, also precise measurements with short transit times so that overall this ensures a simple compact structure and at the same time highly accurate measurement.

The present invention was described hereinbefore by means of embodiments by way of example in conjunction with the associated Figures.

It is self-evident to the man skilled and active in this art however that the configuration of the present invention in accordance with the described Figures and the references used for the respective parts and components in the Figures and in the description as well as the details given by way of example are not to be restrictively interpreted.

In addition the shapes and proportions set forth in the individual Figures are shown predominantly diagrammatically and in simplified form for better understanding. The invention is thus not restricted to the specified views and in particular not to the dimensions and shapes. Rather all configurations and variations which are within the accompanying claims are deemed to form part of the invention.

What is claimed is:

1. A measuring apparatus for detecting a filling level of a fluid (F) in a tank (T) by means of ultrasound signals, comprising
a sensor unit (3) adapted to transmit and receive ultrasound signals, and
an evaluation device (40) adapted to evaluate the received ultrasound signals, wherein
the sensor unit (3) and the evaluation device (40) are arranged on a common assembly (4), and
the assembly (4) is arranged in a housing (2) of the measuring apparatus (1).

2. A measuring apparatus as set forth in claim 1, wherein the evaluation device (40) and the sensor unit (3) are arranged on the assembly (4) in mutually adjacent relationship.

3. A measuring apparatus as set forth in claim 1, wherein the assembly (4) is fixed elastically in the housing (2, 5).

4. A measuring apparatus as set forth in claim 1, wherein the assembly (4) is supported elastically in the housing (2) by means of at least one carrier element (6) and the sensor unit (3) arranged on the assembly (4) is pressed elastically against an inside surface of a housing portion of the housing (2).

5. A measuring apparatus as set forth in claim 4 and further comprising a tube portion (9) which is fluid-tightly fixed in the housing (2) and which serves to accommodate feed lines (11) which are electrically connected to the assembly (4) in a connecting region (16) thereof.

6. A measuring apparatus as set forth in claim 5, wherein a reference surface (12) is arranged on the tube portion (9) at a predetermined spacing relative to the housing (2) and serves to implement a reference measurement.

7. A measuring apparatus as set forth in claim 5, wherein the tube portion (9) has a connecting device (10) for fixing and sealing the tube portion (9) with respect to the tank (T) after the measuring apparatus (1) is fitted into the tank (T).

8. A measuring apparatus as set forth in claim 7, wherein the sensor unit (3) is provided to perform a filling level measurement and emit ultrasound signals in the direction of the housing (2) and is further adapted to implement a reference measurement by means of ultrasound signals and send the ultrasound signals for the reference measurement in the same direction or a direction different therefrom.

9. A measuring apparatus as set forth in claim 8, wherein a reference reflector (18) is arranged in the tank (T) in the region of the tank bottom and a reference section (19) extends from the sensor unit (3) to the reference reflector (18).

10. A measuring apparatus as set forth in claim 9, wherein at least one of the components of the housing (2) or the tube portion (9) is formed from high-quality steel.

11. A measuring apparatus as set forth in claim 1, wherein the sensor unit (3) is arranged on an upper side of the assembly (4) and the evaluation device (40) is arranged on the lower side of the assembly (4).

12. A measuring apparatus as set forth in claim 1 and further comprising a tube portion (9) which is fluid-tightly fixed in the housing (2) and which serves to accommodate feed lines (11) which are electrically connected to the assembly (4) in a connecting region (16) thereof.

13. A measuring apparatus as set forth in claim 12, wherein a reference surface (12) is arranged on the tube portion (9) at a predetermined spacing relative to the housing (2) and serves to implement a reference measurement.

14. A measuring apparatus as set forth in claim 12, wherein the tube portion (9) has a connecting device (10) for fixing and sealing the tube portion (9) with respect to the tank (T) after the measuring apparatus (1) is fitted into the tank (T).

15. A measuring apparatus as set forth in claim 1, wherein the sensor unit (3) is provided to perform a filling level measurement and emit ultrasound signals in the direction of the housing (2) and is further adapted to implement a reference measurement by means of ultrasound signals and send the ultrasound signals for the reference measurement in the same direction or a direction different therefrom.

16. A measuring apparatus as set forth in claim 15, wherein a reference reflector (18) is arranged in the tank (T) in the region of the tank bottom and a reference section (19) extends from the sensor unit (3) to the reference reflector (18).

17. A measuring apparatus as set forth in claim 1, wherein at least one of the components of the housing (2) or the tube portion (9) is formed from high-quality steel.
